(19) United States
(12) Patent Application Publication
(10) Pub. No.: US 2025/0223714 A1
(43) Pub. Date: Jul. 10, 2025

(54) HYDROGEN ISOTOPE TRANSPORT DEVICE AND HYDROGEN ISOTOPE TRANSPORT METHOD

(71) Applicant: Kyoto Fusioneering Ltd., Uji-shi (JP)

(72) Inventor: Satoshi KONISHI, Uji-shi (JP)

(21) Appl. No.: 19/089,010

(22) Filed: Mar. 25, 2025

Related U.S. Application Data
(63) Continuation of application No. PCT/JP2023/034909, filed on Sep. 26, 2023.

(30) Foreign Application Priority Data
Sep. 26, 2022 (JP) 2022-152760

(51) Int. Cl. C25B 13/07; C25B 1/04; C25B 9/23; C25B 9/65; C25B 15/029

(52) U.S. Cl. CPC C25B 13/07; C25B 1/04; C25B 9/23; C25B 9/65; C25B 15/029

(57) ABSTRACT

Provided are a proton conductor 2 obtained by molding a solid electrolyte ceramic using hydrogen ions or ions containing hydrogen as charge carriers into a flat plate shape or a curved surface shape; a pair of hydrogen permeable electrode bodies 31 and 32 that have hydrogen permeability and conductivity and are formed of a solid that is airtight to gases other than hydrogen, and are arranged so as to sandwich the hydrogen ion conductive solid; a pair of media 41 and 42 arranged so as to sandwich the proton conductor 2 and the pair of hydrogen permeable electrode bodies 31 and 32; and a power supply 5 that applies a voltage between the pair of hydrogen permeable electrode bodies 31 and 32 to induce a current.

### CROSS-REFERENCE TO RELATED APPLICATIONS

This application claims the benefit of priority and is a Continuation application of the prior International Patent Application No. PCT/JP2023/034909, with an international filing date of Sep. 26, 2023, which designated the United States, and is related to the Japanese Patent Application No. 2022-152760, filed Sep. 26, 2022, the entire disclosures of all applications are expressly incorporated by reference in their entirety herein.

### TECHNICAL FIELD

The present invention relates to a hydrogen isotope transfer device and a hydrogen isotope transfer method, which are useful for, for example, separation, concentration, and removal of tritium in a nuclear fusion reactor, upgrading of heavy water or concentration and removal of tritium in a heavy water furnace, separation and removal of tritium in nuclear fuel reprocessing, separation, recovery, and removal of tritium used in other general tests and studies, and further, separation of hydrogen isotopes other than tritium such as hydrogen production.

### BACKGROUND OF THE INVENTION

In a nuclear fusion reactor, a mixed fuel containing deuterium and tritium is turned into plasma and held in a vacuum vessel, and energy is extracted from primary neutrons generated in a nuclear fusion reaction to generate power. In a nuclear fusion reactor, a blanket is arranged on an inner surface of a vacuum vessel in order to produce tritium by capturing neutrons produced by a nuclear fusion reaction and to recover heat generated by the nuclear fusion reaction. In addition, a diverter that discharges exhaust gas of plasma not used in the nuclear fusion reaction is also installed.

In the blanket material, lithium reacts with neutrons to produce tritium (3T), an isotope of hydrogen. In order to reuse the produced tritium as fuel, efficient tritium recovery is important. Deuterium and tritium from unburned gas exhausted from the diverter also need to be recovered. Conventionally, various methods for improving the tritium recovery efficiency have been developed, and as one of them, there is a tritium extraction/transfer method disclosed in Patent Literature 1.

In this method, using a diaphragm made of a proton conductive electrolyte in which a substance mainly using hydrogen ions as charge carriers (for example, in addition to ion exchange resins, solid electrolytes such as β″-alumina, montmorillonite, and uranyl phosphate hydride hydrate, and the like) is sandwiched between hydrogen permeable metal membrane electrodes, tritium is continuously separated and extracted from a medium containing tritium in contact with one electrode by making current flow between both electrodes, whereas a pure tritium gas is released from the other electrode into a space separated from the medium by the diaphragm. According to this method, it is possible to extract and transfer tritium at a low partial pressure in the medium into a pure tritium gas at easily usable pressure without using a complicated device or operation.

### PRIOR ART

### Patent Documents

Patent Literature 1: JP 62-210039 A

### SUMMARY OF THE INVENTION

### Problem to be Solved by the Invention

However, in the tritium extraction and transfer method disclosed in Patent Literature 1, a proton conductive electrolyte is used for a diaphragm for separating and extracting tritium, and since the proton conductive electrolyte is a liquid or amorphous substance and does not have self-standing ability, it is difficult to handle as a material, the device configuration and the operation procedure thereof are complicated, and sufficient moldability, strength, and hardness as a constituent member of the device cannot be obtained. Therefore, there are certain limitations on diversification and versatility of configuration and function of the device, and the application range thereof is also limited.

Therefore, the present invention solves such problems, and an object of the present invention is to provide a hydrogen isotope transfer device and a hydrogen isotope transfer method capable of realizing functions and applications by various surface shapes by expanding the application range while simplifying the device and the operation procedure thereof by improving constituent materials of the device in the transfer of tritium.

### Means for Solving the Problems

In order to solve the above problems, a hydrogen transfer device of the present invention includes a hydrogen ion conductive solid obtained by molding a solid electrolyte ceramic using hydrogen ions or ions containing hydrogen as charge carriers into a flat plate shape or a curved surface shape; at least a pair of hydrogen permeable electrode bodies that have hydrogen permeability and conductivity, are formed of a solid electrode that is airtight to gases other than hydrogen, and are arranged so as to sandwich the hydrogen ion conductive solid; a pair of media arranged so as to sandwich the pair of hydrogen permeable electrode bodies in a state of sandwiching the hydrogen ion conductive solid; and an application means configured to apply a voltage between the pair of hydrogen permeable electrode bodies to induce a current.

Further, a hydrogen transfer method of the present invention includes:
a step of arranging a hydrogen ion conductive solid obtained by molding a solid electrolyte ceramic using hydrogen ions or ions containing hydrogen as charge carriers into a flat plate shape or a curved surface shape by being sandwiched between a pair of hydrogen permeable electrodes that have hydrogen permeability and conductivity and are formed of a solid that is airtight to gases other than hydrogen; and
a step of sandwiching the pair of hydrogen permeable electrode bodies in a state of sandwiching the hydrogen ion conductive solid between a pair of media, applying a voltage between the pair of hydrogen permeable electrodes, and transferring hydrogen from one of the media to another medium via the hydrogen ion conductive solid and the pair of hydrogen permeable electrode bodies by a current induced by the voltage.

In the above invention, it is preferable that, in two spaces that are partitioned by the hydrogen ion conductive solid and the pair of hydrogen permeable electrode bodies and to which the pair of media respectively belong, hydrogen in the spaces are removed or added by the induced current to generate two spaces having different gas compositions.

Furthermore, in the above invention, it is preferable to use an electromotive force measuring means configured to measure a hydrogen concentration electromotive force generated by a chemical potential difference in the hydrogen ion conductive solid by one or a plurality of hydrogen permeable electrode bodies that are installed on the hydrogen ion conductive solid and electrically independent of the application means; and a control means configured to adjust a voltage applied by the application means with reference to a value measured by the electromotive force measuring means to control a transfer amount or transfer speed of hydrogen through the hydrogen ion conductive solid and the pair of hydrogen permeable electrode bodies.

In the above invention, it is preferable to regulate movement of substances other than hydrogen between a gas phase of one medium and a substance of another medium of the pair of media. In the above invention, it is preferable to separate a hydrogen isotope generated in a process of transferring hydrogen between the media through the hydrogen ion conductive solid and the pair of hydrogen permeable electrode bodies by using a difference in transfer characteristics of the hydrogen isotope. Further, in the above invention, it is preferable to separate a reactant generated with transfer of hydrogen between the media through the hydrogen ion conductive solid and the pair of hydrogen permeable electrode bodies.

### Effects of the Invention

In the present invention, in the transfer of tritium, a hydrogen ion conductive solid obtained by molding a solid electrolytic ceramic using hydrogen ions or ions containing hydrogen as charge carriers into a flat plate shape or a curved surface shape is used for a transfer pump arranged between media. The hydrogen ion conductive solid is formed of a solid electrolyte ceramic and has high shape fixability and sufficient hardness and strength, so that the hydrogen ion conductive solid is easy to handle as a constituent member of a device, and can be processed into components of various shapes. Therefore, the degree of freedom of device design can be increased, the operation procedure thereof can be saved, and cost reduction of equipment cost and operation cost can be expected.

As a result, according to the present invention, for example, it is possible to realize diversification and versatility of a hydrogen transfer device and method, and expansion of application range, such as separation, concentration, and removal of tritium, upgrading of heavy water or concentration and removal of tritium in a heavy water furnace, separation and removal of tritium in nuclear fuel reprocessing, separation, recovery, and removal of tritium used in other general tests and studies, and further, separation of hydrogen isotopes other than tritium such as heavy water production.

### BRIEF DESCRIPTION OF DRAWINGS

FIG. 1 is an explanatory view schematically showing a schematic configuration of a hydrogen transfer device according to a first embodiment.

FIG. 2 is an explanatory view schematically showing a schematic configuration of a hydrogen transfer device according to a second embodiment.

FIG. 3 is an explanatory view schematically showing a schematic configuration of a hydrogen transfer device according to an embodiment of a third invention.

### DETAILED DESCRIPTION OF THE INVENTION

Hereinafter, embodiments of the present invention will be described in detail. Each embodiment described below exemplifies a device and the like for embodying the technical idea of the present invention, and the technical idea of the present invention does not specify the material, shape, structure, arrangement, and the like of each component to the followings. Various modifications can be made to the technical idea of the present invention within the scope of the claims.

As in each embodiment described below, according to the present invention, the application range of configuration and function of the hydrogen transfer device can be expanded. For example, the present invention can be also applied to separation, concentration, and removal of tritium, upgrading of heavy water or concentration and removal of tritium in a heavy water furnace, separation and removal of tritium in nuclear fuel reprocessing, separation, recovery, and removal of tritium used in other general tests and studies, and further, separation of hydrogen isotopes other than tritium such as heavy water production.

### First Embodiment

### (Configuration of Device)

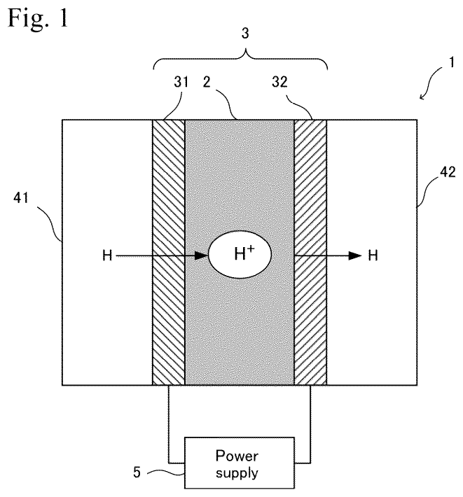

First, a first embodiment of the present invention will be described below. FIG. 1 shows a schematic configuration of a hydrogen transfer device 1 according to the present embodiment. The hydrogen transfer device and the hydrogen transfer method according to the present embodiment are intended to perform separation extraction, pressure increase, and transfer of tritium by one simple device, and can be applied to the configuration and method of a tritium selective pump. In the present embodiment, as shown in FIG. 1, a proton conductor 2 is mainly arranged so as to be sandwiched between a pair of hydrogen permeable electrode bodies 31 and 32 to function as a proton transfer pump 3. The proton conductor 2 is a hydrogen ion conductive solid obtained by molding a solid electrolyte ceramic using hydrogen ions or ions containing hydrogen as charge carriers into a flat plate shape or a curved surface shape.

The proton conductor 2 has electrical conductivity, and charge carriers thereof are ionic substances (electrolytes) containing hydrogen in an atomic group, such as hydrogen ions (H+), hydroxide ions (OH—), or hydronium ions (H3O+). Several types of oxide-based solid electrolyte ceramics can be appropriately used. The proton conductor 2 has moldability, strength, and hardness as a constituent member of the device, and has sufficient self-standing ability and shape fixability that can be attached independently as a part of the device or can be supported by other components such as an electrode of a sensor attached thereto. For example, the proton conductor 2 can be molded into a container or tube having a flat plate or a curved surface as a solid plate having a large area, or can be used as a container in which two different spaces are formed by arranging a plurality of the proton conductors 2 in a tile shape in a plane, and spaces enclosing various media such as gas, liquid, and solid are partitioned.

In addition, the proton transfer pump 3 has a function in which the hydrogen permeable electrode bodies 31 and 32 function as electrodes, charge is supplied to ions in the proton conductor 2 by a voltage applied by a power supply 5, and hydrogen ions are electrochemically exchanged from other medium on the other surface. As the hydrogen permeable electrode bodies 31 and 32, palladium, nickel, platinum, cobalt, alloys thereof and the like can be used. The hydrogen permeable electrode bodies 31 and 32 have conductivity by electrons and holes while being selectively permeable to hydrogen, and can also be mechanically reinforced with a porous or honeycomb structure or the like. Even if it is not a metal, a substance that moves in both hydrogen and electron-hole conduction can be used as the hydrogen permeable electrode bodies 31 and 32.

The entire hydrogen transfer device 1 further includes a pair of media 41 and 42 arranged so as to sandwich the proton transfer pump 3, and the power supply 5 as an application means configured to apply a voltage between the hydrogen permeable electrode bodies 31 and 32 to induce a current. The proton transfer pump 3 is interposed between the media 41 and 42, and a voltage is applied by the power supply 5, so that hydrogen is transferred from one medium 41 to the other medium 42 through the proton transfer pump 3.

In particular, the hydrogen ion conductive solid as the proton conductor 2 is formed of a solid that is airtight state to gases other than hydrogen, and the proton transfer pump 3 is formed by sandwiching such a proton conductor 2 between the hydrogen permeable electrode bodies 31 and 32. By functioning the proton transfer pump 3, it is possible to change the gas composition of the two spaces partitioned by the proton transfer pump 3 and to which the media 41 and 42 respectively belong by the induced current, and two spaces having different gas compositions, such as a space from which hydrogen of one medium is removed and a space to which hydrogen of the other medium is added, are generated in a form including each of the media 41 and 42.

As the media 41 and 42, in addition to a pure tritium-containing hydrogen isotope gas having a low pressure or close to vacuum and a mixed gas containing tritium, a liquid such as a molten metal or a molten salt, a solid in which tritium is dissolved, or the like is conceivable, and the present method can be carried out in principle for any of them. Also, even when tritium is a compound such as H2O or NH3, only tritium can be recovered from the compound by electrolysis when a sufficient voltage is applied.

The power supply 5 is an application means configured to apply a voltage between the pair of hydrogen permeable electrode bodies 31 and 32 to induce a current, and applies a voltage between the pair of hydrogen permeable electrode bodies 31 and 32 by the power supply 5 to transfer hydrogen from one medium 41 to the other medium 42 via the proton transfer pump 3 by the current induced by the voltage.

In the hydrogen transfer device 1 having such a configuration, it is possible to regulate the movement of substances other than hydrogen between the gas phase of the medium on one side and the substance of the medium on the other side via the proton transfer pump 3, at the outside of the proton transfer pump 3, and it can be used as an isotope separation means configured to separate hydrogen isotopes generated in the process of transferring hydrogen through the proton transfer pump 3 by using a difference in transfer characteristics of hydrogen isotopes. Here, the transfer characteristics of isotopes include, for example, in the case of hydrogen, reaction intensity, a transfer amount, a transfer speed, a chemical potential, and the like with respect to a potential difference according to the type of electrode of each of hydrogen, deuterium, and tritium, which are isotopes. By adjusting the voltage current between the hydrogen permeable electrode bodies 31 and 32 according to the difference in the transfer characteristics, it is possible to change the proportion balance of isotopes transferred between the media, and by increasing the desired proportion of isotopes, it is possible to increase the purity of the isotopes.

For example, the medium 41 is a substance containing tritium (in the figure, shown as hydrogen H), from which tritium H is dissociated and dissolved in the hydrogen permeable electrode body 31, and reaches the interface between the hydrogen permeable electrode body 32 and the proton conductor 2 by diffusion and permeation. Here, tritium is ionized (in the figure, shown as hydrogen H+), migrates in the proton conductor 2 according to a potential difference applied between both electrodes 31 and 32, and reaches the hydrogen permeable electrode body 32.

Tritium is atomized again in the hydrogen permeable electrode body 32, permeates through the hydrogen permeable electrode body 32, then becomes tritium gas, and is released to the medium 42. Through this series of processes, tritium is transferred from the medium 41 to the medium 42, and separation extraction from the medium 41 and purification to pure tritium gas of the medium 42 and pressure increase are performed.

Incidentally, the hydrogen transfer device of the present invention can be used as a transfer pump when the media 41 and 42 are tritium gases with a relatively small pressure difference, can be used as recovery, storage, and a supply device of tritium when the medium 42 is a sealed container or a flowing pipeline, and can also be applied as a solid tritium permeation leakage preventing method when the medium 42 side is a solid surface.

### (Operation and Effect)

As described above, in the present embodiment, a plate-like structure composed of the proton conductor 2 and the hydrogen permeable electrode bodies 31 and 32 is allowed to function as the proton transfer pump 3, whereby the proton transfer pump 3, which is the plate-like structure, partitions two spaces as a container wall or a part of the container wall, and substances with which both sides are in contact are defined as the media 41 and 42, respectively. When the media 41 and 42 each contain hydrogen, a voltage is applied to the hydrogen permeable electrode bodies 31 and 32, whereby hydrogen can be transferred from the medium 41 to the medium 42.

At this time, since other elements in the medium do not move, for example, if the media 41 and 42 are both hydrogen gas, the proton transfer pump 3 acts as a simple hydrogen pressurization pump. Also, when the medium 41 is a mixed gas of hydrogen and other gas, the proton transfer pump 3 works as a hydrogen removal/extraction device, and pure hydrogen is obtained on the medium 42 side.

Here, the amount of hydrogen moved between the media 41 and 42 is proportional to the voltage to which the logarithm of the abundance of hydrogen is applied, and is proportional to the current between the media 41 and 42. The effect of this voltage is very large, and a concentration difference of about 10 to the power of 10 can be provided. For example, the hydrogen concentration of the medium 41 can be extremely reduced, or conversely, the hydrogen pressure on the medium 42 side can be set to about 100 atm.

In addition, since the proton conductor 2 contains hydrogen-containing ions and other ions therein, the proton conductor 2 is electrochemically decomposed when a voltage higher than the oxidation-reduction potential thereof is applied. Therefore, the power supply 5 is controlled so as not to load a voltage higher than the voltage.

As a result, according to the present embodiment, it is possible to extract or transfer tritium at a low partial pressure in the medium into a pure tritium gas at easily usable pressure using the proton transfer pump 3 having a simple electrochemical cell structure without using a complicated device or operation.

In particular, a hydrogen ion conductive solid 2 obtained by molding a solid electrolyte ceramic into a flat plate shape or a curved surface shape is used for the proton transfer pump 3 arranged between the media 41 and 42, and since the hydrogen ion conductive solid 2 is formed of the solid electrolyte ceramic, the hydrogen ion conductive solid 2 has high shape fixability and sufficient hardness and strength, is easy to handle as a constituent member of the device, and can be processed into components of various shapes. Therefore, according to the present embodiment, the degree of freedom of device design can be increased, the operation procedure thereof can be saved, and cost reduction of equipment cost and operation cost can be expected.

### Second Embodiment

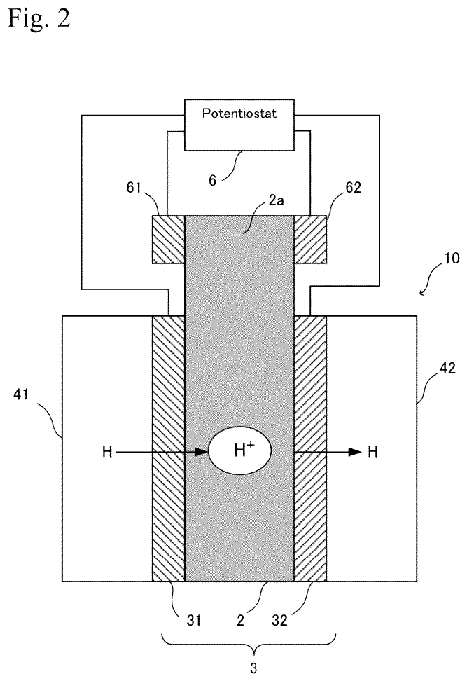

Next, a second embodiment of the present invention will be described. In the present embodiment, an electromotive force measuring means configured to measure a hydrogen concentration electromotive force by a chemical potential difference in a hydrogen ion conductive solid, and a control means configured to control a transfer amount or transfer speed of hydrogen with reference to the value measured by the electromotive force measuring means are provided on a proton conductor 2. FIG. 2 shows a schematic configuration of the hydrogen transfer device according to the present embodiment. In the present embodiment, the same components as those of the first embodiment described above are denoted by the same reference numerals, and functions and the like thereof are the same unless otherwise specified, and the description thereof will be omitted.

As shown in FIG. 2, a hydrogen transfer device 10 according to the present embodiment includes electromotive force measuring means 61 and 62 and a potentiostat 6 as a control means, in addition to the configuration of the hydrogen transfer device 1 described in the first embodiment described above.

The electromotive force measuring means 61 and 62 are one or a plurality of hydrogen permeable electrode bodies that are installed on the proton conductor 2 and electrically independent of the application means, and measure a hydrogen concentration electromotive force by a chemical potential difference in the proton conductor 2. In the present embodiment, the electromotive force measuring means 61 and 62 are arranged as a pair of hydrogen permeable electrode bodies so as to sandwich an upper extended portion 2a of the proton conductor 2, the electromotive force measuring means 61 is attached to the side surface of the upper extended portion 2a on the medium 41 side, and the electromotive force measuring means 62 is attached to the side surface of the upper extended portion 2a on the medium 42 side.

These electromotive force measuring means 61 and 62 are connected to the proton conductor 2 while being separated from hydrogen permeable electrode bodies 31 and 32, and are electrically independent from the hydrogen permeable electrode bodies 31 and 32. Note that the electromotive force measuring means 61 and 62 are fixed to and supported by the proton conductor 2, and a plurality of sets of electrodes can be separated from each other and electrically independent from each other and arranged on the surface of the proton conductor 2 with a pair sandwiching the proton conductor 2 as one set.

In the present embodiment, the potentiostat 6 is a power supply device that is provided in place of the power supply 5 described above, uses the electromotive force measuring means 61 and 62 as reference electrodes, functions with the hydrogen permeable electrode bodies 31 and 32 as working electrodes, and has both functions of the application means and the control means of the present invention.

The potentiostat 6 adjusts the voltage applied between the pair of hydrogen permeable electrode bodies 31 and 32 while maintaining the potential between the hydrogen permeable electrode bodies 31 and 32 with respect to the reference electrode constant, with reference to the value measured by the electromotive force measuring means 61 or 62, changes the current induced in the proton conductor 2, and tracks the change in the electrode reaction rate (current) at that time, thereby adjusting the electrode reaction in the hydrogen permeable electrode bodies 31 and 32 so as to have an arbitrary potential to control a transfer amount or transfer speed of hydrogen through the proton transfer pump 3.

In addition, since the ratio of the hydrogen concentration between the media 41 and 42 is measured by the electromotive force generated in the electrodes of the electromotive force measuring means 61 and 62, the ratio of the hydrogen concentration between the two can be controlled by measuring and controlling the voltage. In the present embodiment, the proton conductor 2 is a solid plate, but it is known that the components flow out to the media 41 and 42 and are lost, and the proton conductivity is deteriorated. In the present embodiment, since the proton conductor 2 is covered with the hydrogen permeable electrode bodies 31 and 32 capable of preventing evaporation other than hydrogen, the proton conductor 2 can be continuously used for hydrogen transfer in a state where the performance of the proton conductor 2 does not change for a long period of time.

The uptake of hydrogen in the hydrogen permeable electrode bodies 31 and 32 and the transfer speed of hydrogen ions in the proton conductor 2 have different properties for each isotope, that is, transfer characteristics. Generally, the lighter the isotope of hydrogen is, the faster it moves. Thus, when there is a mixture of hydrogen and deuterium in the medium 41, a small amount of protium is concentrated in the medium 42. Therefore, according to the present embodiment, the hydrogen isotope can be separated using this property.

The medium 41 and the medium 42 of the hydrogen transfer device 1 according to the present embodiment are spaces partitioned by the proton transfer pump 3, and by configuring one or both of the medium 41 and the medium 42 such that the gas flows, the ratio of the component in each composition can be changed in the flow direction. In the present embodiment, by attaching a plurality of electrodes to the proton conductor 2, it is possible to control the concentration of components such as gas to be produced, for example, hydrogen, whereby the hydrogen transfer device 10 can be applied as a chemical reactor.

### Third Embodiment

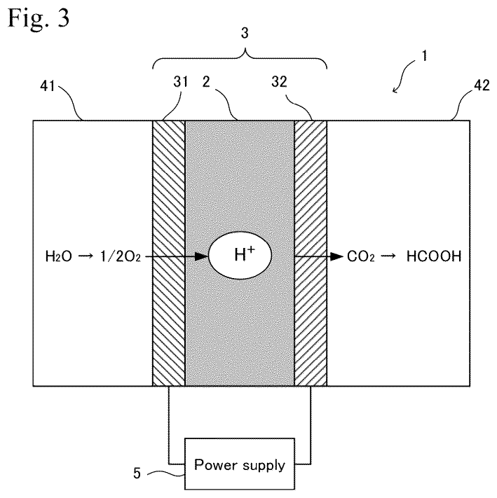

Next, a third embodiment of the present invention will be described. In the present embodiment, the hydrogen transfer device 1 described in the first embodiment described above is used as a reactant separation means configured to separate a reactant generated with transfer of hydrogen. FIG. 3 shows a schematic configuration of the hydrogen transfer device according to the present embodiment. In the present embodiment, the same components as those of the first embodiment described above are denoted by the same reference numerals, and functions and the like thereof are the same unless otherwise specified, and the description thereof will be omitted.

A gas that fills a medium 41 and a medium 42 is not limited to hydrogen isotope gas. For example, when the medium 41 is water or water vapor, hydrogen ions are extracted from the medium 41 through a proton transfer pump 3 and applied to the medium 42, and for example, when the medium 42 is a closed space in which CO2 is enclosed, the gas can be changed to a compound of CHO. In this reaction, for example, CO2 in the space to which the medium 41 belongs, such as CO2+3H2=CH3OH+H2O, can also be changed to other useful compounds in the other space to which the medium 42 belongs. That is, according to the present embodiment, the hydrogen transfer device 1 can also be applied as an electrochemical reactor that causes a chemical reaction involving hydrogen as intended.

### Modified Example

Note that the present invention is not limited to the above-described embodiments as they are, and the components can be modified and embodied without departing from the gist thereof in the implementation stage. In addition, various inventions can be formed by appropriately combining a plurality of components disclosed in the above embodiments. For example, some components may be deleted from all the components shown in the embodiments.

For example, the configuration of the proton transfer pump 3 is not limited to a flat plate as long as the proton transfer pump 3 has a structure in which the solid proton conductor 2 is sandwiched between the hydrogen permeable electrode bodies 31 and 32, and a complicated surface structure having a large specific surface area may be provided, or a large number of one-side sealed pipes may be arranged to set a large electrode area in a limited space.

### REFERENCE SIGNS LIST

1 Hydrogen transfer device
2 Proton conductor
2a Upper extended portion
3 Proton transfer pump
5 Power supply
6 Potentiostat
10 Hydrogen transfer device
31, 32 Hydrogen permeable electrode body
41, 42 Medium 61, 62 Electromotive force measuring means

1. A hydrogen isotope transfer device comprising:
a hydrogen ion conductive solid obtained by molding a solid electrolyte ceramic using hydrogen ions or ions containing hydrogen as charge carriers into a flat plate shape or a curved surface shape;
at least a pair of hydrogen permeable electrode bodies that have hydrogen permeability and conductivity, are formed of a solid that is airtight to gases other than hydrogen, and are arranged so as to sandwich the hydrogen ion conductive solid;
a pair of media arranged so as to sandwich the pair of hydrogen permeable electrode bodies in a state of sandwiching the hydrogen ion conductive solid; and
an application means configured to apply a voltage between the pair of hydrogen permeable electrode bodies to induce a current.

2. The hydrogen isotope transfer device according to claim 1, wherein, in two spaces that are partitioned by the hydrogen ion conductive solid and the pair of hydrogen permeable electrode bodies and to which the pair of media respectively belong, hydrogen isotopes in the spaces are removed or added by the induced current to generate two spaces having different gas compositions.

3. The hydrogen isotope transfer device according to claim 1, further comprising:
an electromotive force measuring means configured to measure a hydrogen concentration electromotive force generated by a chemical potential difference in the hydrogen ion conductive solid by one or a plurality of hydrogen permeable electrode bodies that are installed on the hydrogen ion conductive solid and electrically independent of the application means; and
a control means configured to adjust a voltage applied by the application means with reference to a value measured by the electromotive force measuring means to control a transfer amount or transfer speed of hydrogen through the hydrogen ion conductive solid and the pair of hydrogen permeable electrode bodies, or a ratio of hydrogen isotope concentrations between both media.

4. The hydrogen isotope transfer device according to claim 1, wherein movement of substances other than hydrogen between a gas phase of one medium and a substance of another medium of the pair of media is regulated.

5. The hydrogen isotope transfer device according to claim 1, further comprising a function of separating a hydrogen isotope generated in a process of transferring hydrogen between the media through the hydrogen ion conductive solid and the pair of hydrogen permeable electrode bodies by using a difference in transfer characteristics of the hydrogen isotope.

6. The hydrogen isotope transfer device according to claim 1, further comprising a function of separating a reactant generated with transfer of hydrogen between the media through the hydrogen ion conductive solid and the pair of hydrogen permeable electrode bodies.

7. A hydrogen isotope transfer method comprising:
a step of arranging a hydrogen ion conductive solid obtained by molding a solid electrolyte ceramic using hydrogen ions or ions containing hydrogen as charge carriers into a flat plate shape or a curved surface shape by being sandwiched between a pair of hydrogen permeable electrodes that have hydrogen permeability and conductivity and are formed of a solid that is airtight to gases other than hydrogen; and
a step of sandwiching the pair of hydrogen permeable electrode bodies in a state of sandwiching the hydrogen ion conductive solid between a pair of media, applying a voltage between the pair of hydrogen permeable electrodes, and transferring a hydrogen isotope from one of the media to another medium via the hydrogen ion conductive solid and the pair of hydrogen permeable electrode bodies by a current induced by the voltage.

8. The hydrogen isotope transfer method according to claim 7, further comprising a step of, in two spaces that are partitioned by the hydrogen ion conductive solid and the pair of hydrogen permeable electrode bodies and to which the pair of media respectively belong, removing or adding hydrogen in the spaces by the induced current to generate two spaces having different gas compositions.

9. The hydrogen isotope transfer method according to claim 7, further comprising:
a step of measuring a hydrogen concentration electromotive force generated by a chemical potential difference in the hydrogen ion conductive solid by one or a plurality of hydrogen permeable electrode bodies that are installed on the hydrogen ion conductive solid and electrically independent of the application means; and
a step of adjusting a voltage applied to the hydrogen ion conductive solid and the pair of hydrogen permeable electrode bodies with reference to a value measured by the electromotive force measuring means to control a transfer amount or transfer speed of hydrogen through the hydrogen ion conductive solid and the pair of hydrogen permeable electrode bodies.

10. The hydrogen isotope transfer method according to claim 7, further comprising a step of regulating movement of substances other than hydrogen between a gas phase of one medium and a substance of another medium of the pair of media.

11. The hydrogen isotope transfer method according to claim 7, further comprising a step of separating a hydrogen isotope generated in a process of transferring hydrogen between the media through the hydrogen ion conductive solid and the pair of hydrogen permeable electrode bodies by using a difference in transfer characteristics of the hydrogen isotope.

12. The hydrogen isotope transfer method according to claim 7, further comprising a step of separating a reactant generated with transfer of hydrogen between the media through the hydrogen ion conductive solid and the pair of hydrogen permeable electrode bodies.
